(19) United States
(12) Patent Application Publication
(10) Pub. No.: US 2026/0358672 A1
(43) Pub. Date: Nov. 12, 2026

(54) MULTIPLE-SOURCE MULTIPLE-INJECTION RING RESONATORS AND AN OPTICAL FIELD PROGRAMMABLE GATE ARRAY

(71) Applicant: Ramot at Tel-Aviv University Ltd., Tel-Aviv (IL)

(72) Inventors: Roei Aviram COHEN, Tel-Aviv (IL); Ofer AMRANI, Tel-Aviv (IL); Shlomo RUSCHIN, Tel-Aviv (IL)

(73) Assignee: Ramot at Tel-Aviv University Ltd., Tel-Aviv (IL)

(21) Appl. No.: 19/142,255

(22) PCT Filed: Dec. 22, 2023
(86) PCT No.: PCT/IL2023/051299

§ 371 Date: Jun. 23, 2025

Related U.S. Application Data
(60) Provisional application No. 63/434,529, filed on Dec. 22, 2022.

(51) Int. Cl. G02F 1/225; G02F 1/313

(52) U.S. Cl. CPC G02F 1/2257; G02F 1/3133; G02F 2203/15

(57) ABSTRACT

An optical response shaper and/or modulator device with multiple injection has a resonator having an enclosed geometric structure, and two injection optical waveguides between an input port and a second end which approach the resonator at respective approach points. Coupling regions are located at the respective approach points, and provide optical coupling between the resonator and the injecting waveguides. The coupling regions inject two light signals to the resonator, each light signal having been inputted from a different input port and having a respectively different wavelength, and the two light signals move in the resonator in a single rotational sense. An output port at the far end of one of the injection optical waveguides provides shapes of frequency or time responses for each light signal respectively, according to parameters of the injecting waveguides or of the coupling regions, such that each light signal is mapped to a distinct output response.

### RELATED APPLICATION/S

This application claims the benefit of priority of U.S. Provisional Patent Application No. 63/434,529 filed on 22 Dec. 2022, the contents of which are incorporated herein by reference in their entirety.

### FIELD AND BACKGROUND OF THE INVENTION

The present invention, in some embodiments thereof, relates to mulitiple-source multiple-injection ring resonators and further to an optical field programmable gate array constructed therewith.

In US Patent Application No US 2020/0059068 A1 to the present inventors, the FLAME device was introduced. The flame is an optical device capable of shaping of a frequency response, or otherwise an electrical-to-optical response by means of a racetrack resonator designed and fabricated in, the so-called, Double Injection configuration. The Double Injection approach has a unique property that allows two Free Spectral Range states to exist for a single racetrack length. Shaping is realized by properly selecting different coupling coefficients that provide a variety of interesting transmissions. Various response shapes were demonstrated including: sinusoidal, triangular (linearizer), square (bandpass, “box-like” filter), notch (2 states), insensitive 20 dB filter, Fano resonance, and interleaver.

### SUMMARY OF THE INVENTION

The present embodiments relate to injections from multiple sources, and to keeping the responses from the separate injections distinguishable at the output.

According to an aspect of some embodiments of the present invention there is provided an optical response shaper and/or a modulator device with multiple injection, the device comprising:
a resonator having an enclosed geometric structure;
at least two injection optical waveguides between an input port and a second end, the optical waveguides approaching the resonator at respective approach points;
coupling regions between the resonator and the injecting waveguides at the approach points respectively, the coupling regions providing optical coupling between the resonator and the injecting waveguides, the coupling regions being configured to inject at least two light signals to the resonator at the approach points, each light signal having a respective wavelength, the coupling regions being configured to inject the at least two light signals to move in the resonator in a single rotational sense; and
an output port at a second end of (at least) one of the injection optical waveguides for providing a plurality of shapes of frequency or time responses for each input signal respectively, according to parameters of the injecting waveguides or of the coupling regions, such that each input is mapped to a distinct output response.

Thus a single device receives optical signals of independent wavelengths at independent ports and processes them through the same resonator. Different settings on the device have different effects on the different wavelengths and thus the two signals may be controlled independently so that two independent inputs give two independent outputs. In one embodiment, the device is an optically linear device. That is to say the optical waveguides and the resonator are linear in the optical domain, each wavelength thereby being transmitted independently through the optical response shapper without direct mutual influence among the respective wavelengths.

As an alternative, the device may be non-linear in the optical domain. In the case of a device incorporating non-linear optical material, the control signal may be optical too, achieving optical control in a full or partial fashion.

The optical response shaper may be an optically linear device, and may comprise active tunable elements, the active tunable elements being configured to control different wavelengths differently.

In embodiments, the active tunable elements are configured to affect different wavelengths simultaneously and respectively differently.

In embodiments, the active tunable elements comprise couplers and phase shifters at the coupling regions, the couplers and phase shifters being tunable by applied voltages or by temperature or by induced stress or by optical power via a nonlinear effect.

Embodiments may comprise one or more phase shifting element.

Embodiments may comprise one or more additional active tunable element.

Embodiments may comprise one or more electrode placed at the vicinity of one or more of the active tunable elements, the additional electrode being for programmably altering a respective coupling coefficient to vary the predetermined frequency response or time response.

Embodiments may comprise one or more heating element placed at the vicinity of one or more of the active tunable elements, the heating element being for programmably altering a respective coupling coefficient by controllably altering a temperature, thereby to vary resulting frequency responses or time responses.

Embodiments may comprise an electrode over each coupling region respectively, thereby to alter coupling coefficients at each coupling region.

Embodiments may comprise phase shifting elements associated with the waveguides, the phase shifting elements being external to the resonator.

In embodiments, at least three or at least four input ports may be provided.

The paramaters that may be varied include resonator parameters, tuning electrode parameters, voltages, temperatures, stress, optical power or any known phenomenon that change the phase or amplitude of the light wave.

In embodiments, any of an applied voltage, a temperature, an induced stress and optical power may be provided to one or more of the tunable elements as a control signal.

An array of two or more optical response shapers may be provided.

In such an array, active tunable elements on each optical response shaper may be set to give an overall array output.

The array may provide a permutation matrix for controlled routing.

The array may provide dynamic switching operations.

The array may provide a Butler matrix, which may be an active Butler matrix comprising the tunable elements in the array

The array may provide an artificial neural network.

The array may form an optical field programmable gate array (OFPGA).

The OFPGA may include tuning elements, the tuning elements having inputs, the array allowing field programming by changing tuning element inputs consisting of control voltages, and/or temperature.

The tuning elements may be any of couplers, phase-shifters and electrodes.

Active tunable elements may comprise couplers at the coupling regions, the couplers being tunable by applied voltages or temperature-dependent signals.

In embodiments, the active tunable elements comprise filters, the filters being tunable by applied voltages or temperature-dependent signals.

The elements may include one or more phase shifting element.

Embodiments may include at least seven active tunable elements.

Embodiments may comprise one or more electrode placed at the vicinity of one or more of the active tunable elements, the additional electrode being for programmably altering a respective coupling coefficient to vary the predetermined frequency response or time response for a respective wavelength.

An electrode may be provided over each coupling region respectively, thereby to alter coupling coefficients at each coupling region.

The device may be a triple injection device, having at least three input ports.

A device may have at least four input ports, to constitute a multiple injection device.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified diagram of a double injection resonator according to embodiments of the present invention;

FIG. 2 is a triple injection resonator according to embodiments of the present invention;

FIG. 3 is a variation of the double injection resonator of FIG. 1 where the geometry is modified to fit in a grid;

FIG. 4 is a simplified diagram of a grid of the devices of FIG. 1;

FIGS. 5A and 5B are layout and schematic diagrams respectively of a two-input two output FLAME device according to embodiments of the present invention;

FIG. 6 is a simplified diagram that shows a 4 by 4 configurable matrix 80 using an array of FLAME devices with four optical input ports and four optical output ports;

FIG. 7 is a simplified device showing a three-input device and tunable controlling electrodes; and

FIG. 8 is a simplified diagram which schematically illustrates an exemplary array (OFPGA) 90 based on 4 triple-injection devices.

### DESCRIPTION OF SPECIFIC EMBODIMENTS OF THE INVENTION

The present invention, in some embodiments thereof, relates to multiple-source multiple-injection ring resonators and further to an optical field programmable gate array constructed therewith.

An optical response shaper and/or a modulator device with multiple injection, according to the present embodiments comprises a closed resonator, at least two injection optical waveguides between an input port and a second end, the optical waveguides approaching the resonator at respective approach points, coupling regions between the resonator and the injecting waveguides at the approach points, the coupling regions providing optical coupling between the resonator and the injecting waveguides, the coupling regions being configured to inject at least two light signals to the resonator, each light signal having a respective wavelength; and an output port at a second end of one of the injection optical waveguides for providing a plurality of shapes of frequency or time responses for each input wave respectively, according to parameters of the injecting waveguides or of the coupling regions such that each input wave is mapped to a distinct output response.

Thus injections may be obtained from multiple sources, and the responses from the separate injections may nevertheless be distinguishable at the output.

An array of such devices may provide an optical equivalent of a programmable gate array, that is to say an optical field programmable gate array.

### Multiple-Injections-Multiple Wavelength Device:

As a further development of the FLAME device of the above-cited document, wavelength diversity is proposed, meaning that optical signals at different wavelengths, from possibly multiple light sources, are injected to the input ports, and then the inputs may be manipulated in a wavelength-dependent fashion for each input wavelength. The manipulation may be in both or either of the time and/or frequency domains. The number of input ports can be two, to which we refer to as a “Double Injection resonator” (DIR), three—“Triple Injection resonator” (TIR), or more—“Multiple Injection resonator” (MIR). As long as the different elements of the device are linear in the optical domain, each wavelength may be transmitted independently through the device without direct mutual influence among different wavelengths, and the control of radiation at different wavelengths may be achieved by the incorporated active tunable elements: couplers and filters, which are activated by applied voltages or temperature time-dependent signals.

In case of a device incorporating non-linear optical material, the control signal may be optical too, achieving optical control in full or partial fashion. The option of wavelength diversity adds an additional dimension to the switching and modulating functions of the device.

### Optical Field-Programmable Gate Array (OFPGA):

By constructing an array of several properly inter-connected MIR devices one can assemble an integrated optical device capable of performing diverse matrix-like operations on an incoming set of optical signals—and we refer to such an embodiment herein as an Optical Field-Programmable Gate Array (OFPGA). In other words, OFPGA may provide an integrated optical device accepting multiple optical inputs, possibly of different wavelengths, possibly from multiple optical sources, with optical functionality that can be tuned in the field, meaning during operation, by changing control voltages, or temperature in tuning elements that may be incorporated therein, such as couplers, phase-shifters and electrodes.

By means of the control signals of each element of the array, a variety of array functions may be simultaneously carried out e.g. spatial and wavelength routing, combining, and splitting as well as data processing options, matrix operations and mathematical transforms. Such an array may be further utilized as a building block for implementing optical-based neural networks.

The technology aims at providing high speed, low power, highly integrated optical photonic devices, which may be implemented in ASIC chips, and which may have programmable functionality.

The present embodiments may provide small foot-print components that can be easily re-programmed to obtain a required complex functionality, without having to dismount, re-connect or re-route circuitry, and which may therefore be similar to an electrical FPGA. Such a device may further be utilized as a building block for implementing an optical-based neural network.

Arrays of multiple-injection ring elements are disclosed comprising a multiplicity of radiation sources with different wavelengths fed into N input ports of the array. The elements may be simultaneously processed and routed unto the M output ports of the array. By means of the controlling signals of each element of the array, a variety of array functions may be achieved, e.g. spatial and wavelength routing, combining, and splitting as well as data processing options, matrix operations, and mathematical transforms.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

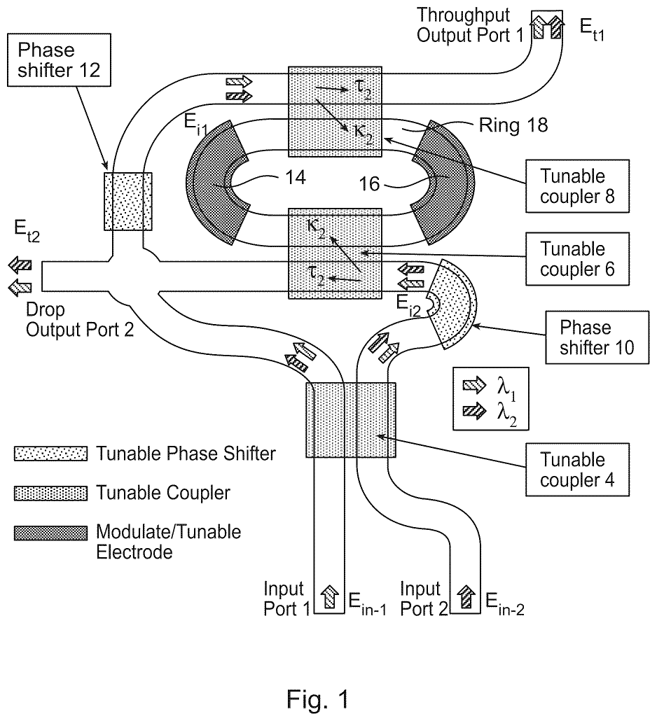

Referring now to the drawings, FIG. 1 is a simplified diagram showing a device according to an embodiment of the present invention. The device is structurally similar to the detailed enlarged unit in FIG. 11 of the above-referenced Patent application (US 2020/0059068), the main differences consisting of the fact that two ports are utilized (input port 1 and input port 2), and in each one, a different wavelength is injected, so that the two signals do not influence one another. After passing tunable coupler 4, the two wavelengths are intermixed at the output ports of tunable coupler 4. Further mixing between the two optical signals at different wavelengths takes place in Tunable Couplers 6 and 8. In Phase Shifters 10 and 12, the propagating optical signals acquire additional controllable phase shifts, in general, in a wavelength-dependent fashion. Two modulating electrodes 14 and 16, located in the ring 18 provide the function of high-frequency modulation of the transmitted radiation. A total of seven tunable elements are thus displayed in FIG. 1, which, as controllable elements, provide between them seven dynamically variable degrees of freedom which may provide a large diversity of transmission functions, distinct for each output optical wavelength.

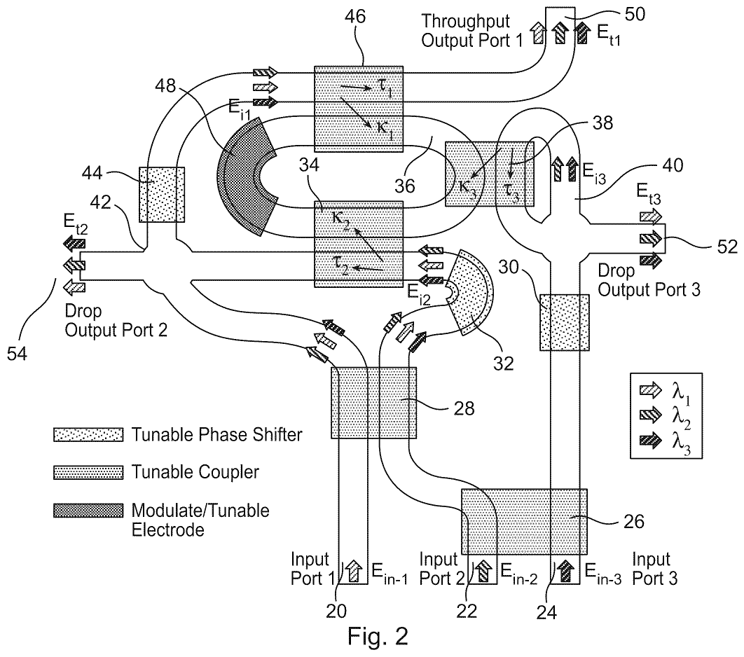

Reference is now made to FIG. 2, which is a simplified diagram illustrating an extension of the embodiment of FIG. 1 to the case of three input and three output ports. At the three input ports 20, 22 and 24, three optical signals of different wavelengths are injected and propagate in a controllable fashion through the device. A coupler 26 is added between inputs 22 and 24. Coupler 28 is added between inputs 20 and 22 further down the line. Tunable phase shifter 30 is added after coupler 26 on the line from input 24. Tunable phase shifter 32 is provided on the line from input 22 following coupler 28 and prior to coupler 34 that couples the line from input 32 to ring 36. The line from input 24 is coupled to ring 36 via coupler 38 which itself lies on loop 40. The line from output 20 meets the line from output 22 at junction 42, then passes through tunable phase shifter 44 and then is coupled to ring 36 via coupler 46. Tunable electrode 48 is located on ring 36. Three output ports are present, throughput output port 50, and drop output ports 52 and 54. In general, the disposition of tunable couplers and phase-shifters may be varied within the device as required by the functional requirement of the device and system. In addition, the number of input and output ports can be enlarged to four and more.

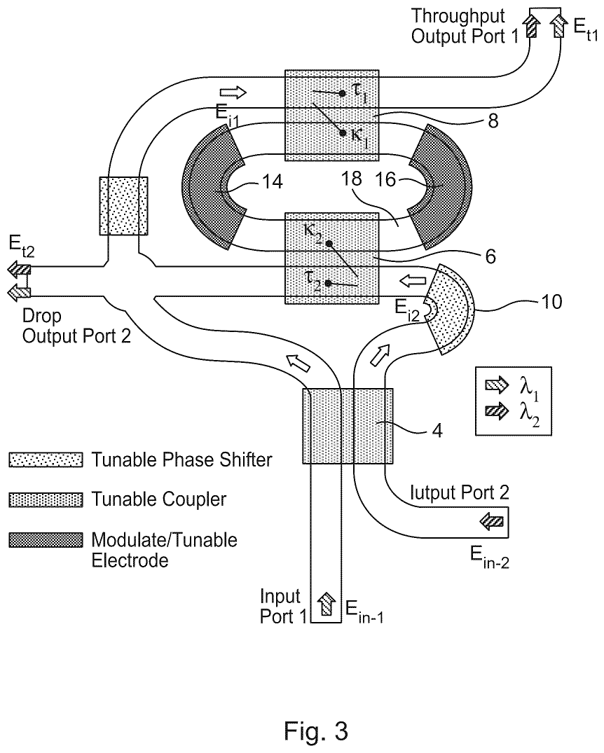

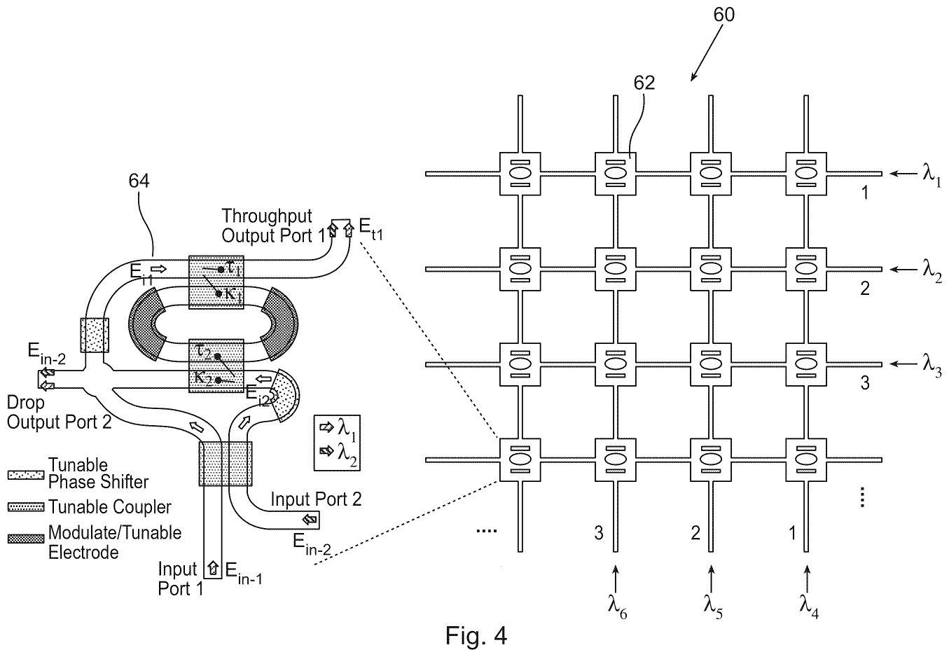

Reference is now made to FIG. 3, which is a simplified diagram showing a device that is similar to that of FIG. 1, except that the geometry of the ports is aligned so as to better suit the array structure to be discussed hereinbelow with respect to FIG. 4. Again, two input ports are utilized (input port 1 and input port 2), and in each one, a different wavelength is injected, so that the two signals do not influence one another. The two input ports are arranged at right angles to receive signals from different angles in a grid. After passing tunable coupler 4, the two wavelengths are intermixed at the output ports of tunable coupler 4. Further mixing between the two optical signals at different wavelengths takes place in Tunable Couplers 6 and 8. In Phase Shifters 10 and 12, the propagating optical signals acquire additional controllable phase shifts, in general, in a wavelength-dependent fashion. Two modulating electrodes 14 and 16, located in the ring 18 provide the function of high-frequency modulation of the transmitted radiation.

Reference is now made to FIG. 4, which shows the incorporation of the device of FIG. 1 into an array 60 similar to that of FIG. 11 in the above-cited patent application. In the present variation, a multiplicity of optical signals with different wavelengths are fed into the N input ports of the array and are simultaneously processed and routed unto the M output ports of the array. That is to say, each node 62 of the array is a device as shown in one of the above figures, e.g. device 64, and each node obtains at least two inputs from the grid and provides outputs to the grid.

By means of controlling the various tunable elements of the array 60, a variety of array functions can be simultaneously achieved e.g. spatial and wavelength routing, combining, and splitting as well as data processing options, matrix operations, and other mathematical transforms that may enable optical OFDM, and provisions for neural network calculations.

By using an array of FLAME devices as shown in FIG. 4, one can provide a device capable of performing some matrix-like operations on an incoming set of optical signals- and thus provide an OFPGA (Optical Field Programmable Gate Array). Namely, a device is provided that has optical functionality and that can be tuned in the field by changing control voltages, or temperature of tuning elements such as couplers, phase-shifters and electrodes.

There may for example be provided a device having M optical inputs, and N optical outputs, N and M being arbitrary, whereby the N optical outputs are some function of the M optical inputs.

Such a configuration may provide functionality such as: routing, switching, Butler matrix, etc.

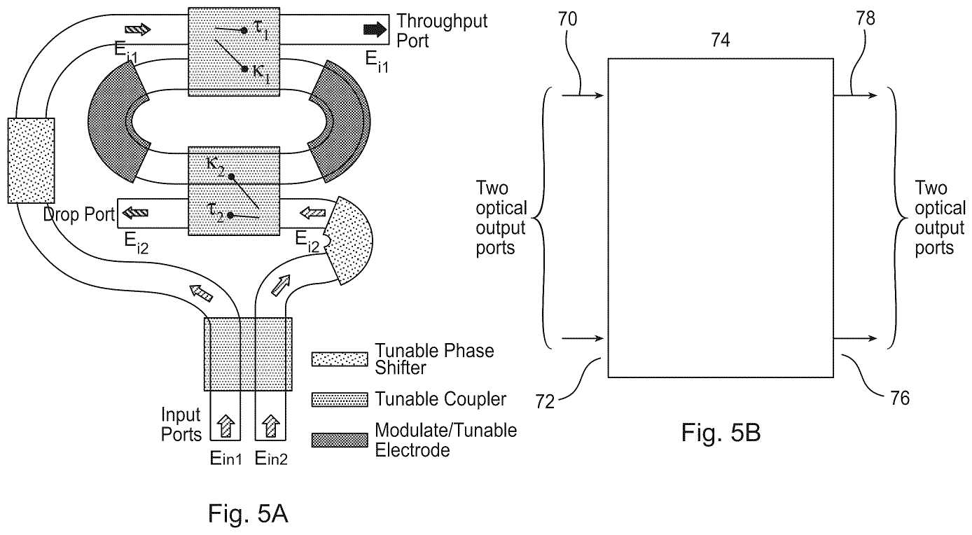

A 4×4 Example (N=M=4), may use as its node the basic 2 input 2 output double injection FLAME example given in FIG. 5A, which is schematically defined in FIG. 5B. The device of FIG. 5A is the same as that described above in respect of FIGS. 1 and 3, with the difference that the two inputs are laid out parallel to each other. The remainder of the layout is as described hereinabove. The schematic in FIG. 5B shows two optical input ports, 70 and 72, a function box 74 and two optical output ports 76 and 78. The tunable features allow for a wide range of functions to be implemented in function box 74.

When operated in the linear region, the relation between the device two optical inputs with relation to the two optical inputs can be formulated by a 2×2 matrix, P, of complex elements, whose specific values can be manipulated by control voltages applied to the different electrical electrodes.

Note that with the absence of electrical electrodes the matrix can be pre-determined by design and the corresponding fabricated device will provide a fixed operation. Clearly, any of the electrodes can be eliminated if corresponding modulation\phase shift\coupling is not mandatory.

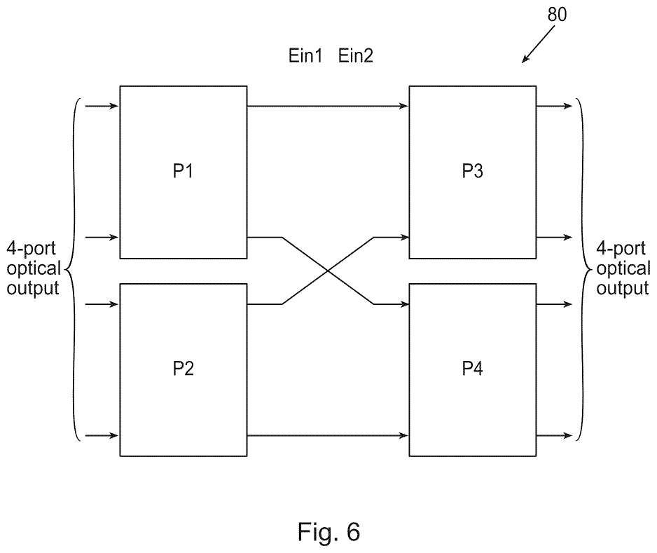

Reference is now made to FIG. 6 which is a simplified diagram that shows a 4 by 4 configurable matrix 80 using an array of FLAME devices with four optical input ports and four optical output ports. FIG. 6 may be implemented using four (2×2) FLAME devices P1 . . . . P4 for obtaining a 4×4 configurable matrix operation. We denote the four 2×2 matrices by P1, P2, P3, P4 as realized by the four FLAME devices. The overall functionality of the array depicted in FIG. 2 can be described by a 4×4 matrix with complex entries as described below.

Denote by the vectors x and y the 4-input and 4-output optical signals (instantaneous amplitude and phase), respectively.

Let us denote by A the 4×4 matrix representing the two left-hand FLAME devices in FIG. 2. Clearly, this matrix is given by:

$$A = [ \begin{matrix}P 1 & 0 \\ 0 & P 2\end{matrix} ] ;$$

Likewise, denote by B the 4×4 matrix representing the two right-hand FLAME devices:

$$B = [ \begin{matrix}P 3 & 0 \\ 0 & P 4\end{matrix} ] ,$$

where 0 denotes a 2×2 null matrix.

Finally, let Ĩ denote the interleaving operation that the 4 outputs from the left-hand matrix A undergo prior to entering the left-hand operation given by matrix B:

$$\tilde{I} = [ \begin{matrix}1 & 0 & 0 & 0 \\ 0 & 0 & 1 & 0 \\ 0 & 1 & 0 & 0 \\ 0 & 0 & 0 & 1\end{matrix} ] ,$$

where {0,1} are real numbers.

Consequently, the operation performed by the array given in FIG. 6 can be formulated as:

y=B·Ĩ·A·x.
A 3×3 example\6×6 example.

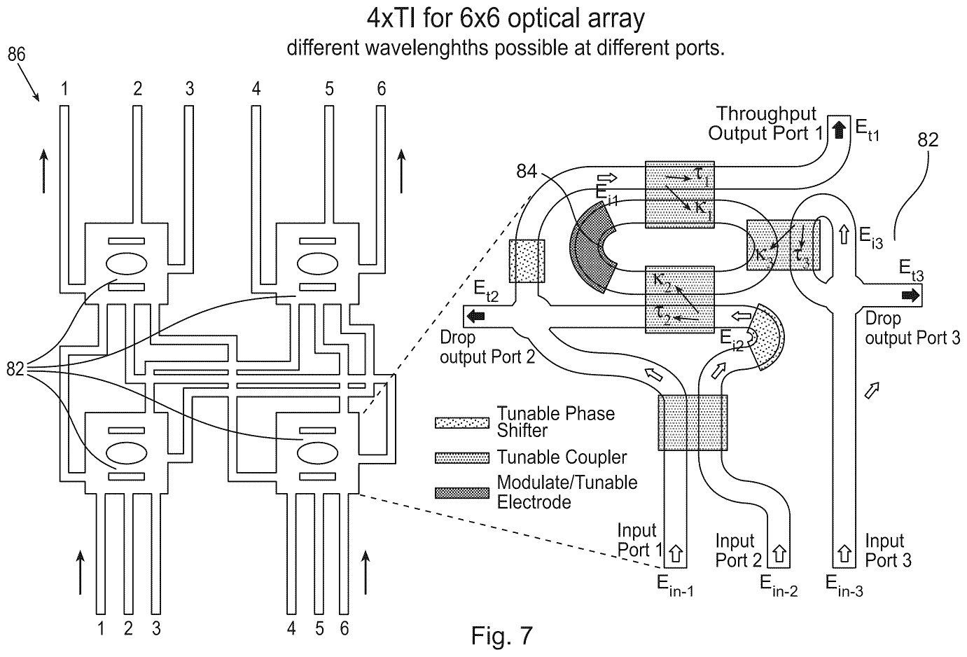

A 3×3\6×6 example may use a triple-injection device as an alternative to the double injection device depicted in FIG. 5A. FIG. 15 in the above-cited patent application depicts a triple-injection device without electrodes. FIG. 7 herein shows a triple-injection device 82 with electrodes 84. Alongside is shown an example array 86 whose nodes are made up of the same triple-injection devices 82 shown alongside.

### Configurability of an M×N Matrix Operation

By proper selection of electrical control (voltages), an M×N matrix operation can be set to provide some desirable functionality—for example: configurable permutation matrix for controlled routing; switching operations; and Butler matrix functionality.

A Butler matrix is a matrix used in an optical beamforming network to feed phased array antenna elements. A purpose of such a Butler matrix is to control the direction of the emitted beam. The matrix is passive and contains fixed-value phase shifters which provide phase difference between elements in order to steer the beam in the desired direction.

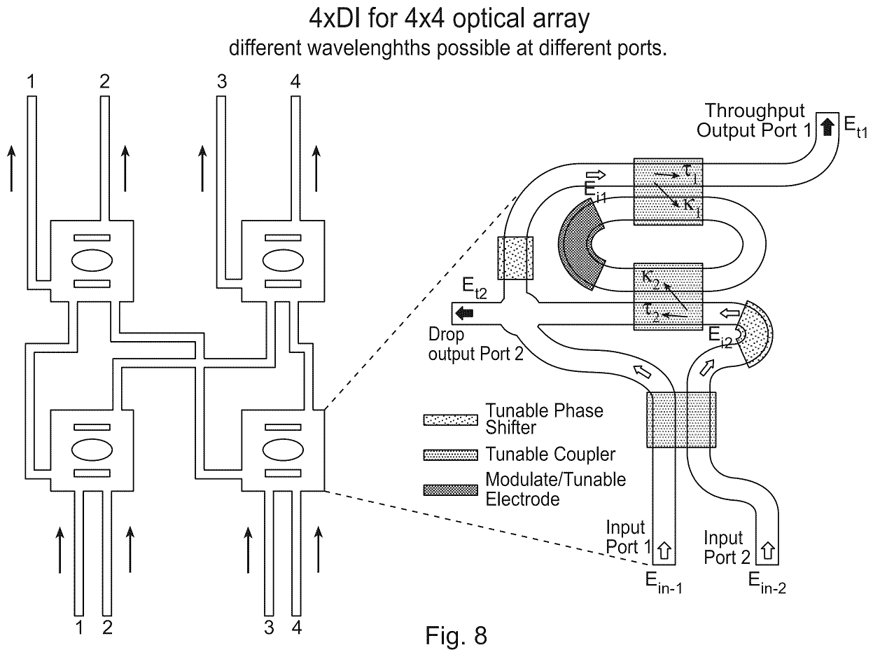

Reference is now made to FIG. 8 which schematically illustrates an exemplary array (OFPGA) 90 based on 4 triple-injection devices 92, of which such a triple-injection device example 94 is depicted on the right.

### Configurability of an M×N Matrix Operation

By proper selection of electrical control (voltages), an M×N matrix operation can be set to provide some desirable functionality—for example: configurable permutation matrix for controlled routing; switching operations; butler matrix functionality.

### Artificial Neural-Network (ANN) Implementation Via Multiple-Injection Array

Mimicking Biological neural networks (BNN) with electronic or photonic hardware is also called neuromorphic computing. Compared with the ANNs directly based on biological neural cells, indirect ANNs rely on electronic or photonic systems containing artificial neurons to indirectly mimic the neurobiological architectures of BNNs.

An ANN is a network consisting of a grid of interconnections, weighting, and activation functions, a.k.a. transfer functions. The execution of a task involves simultaneous activation of a large number of artificial neurons given a set of inputs from the other artificial neurons. Many of the aforementioned ANN elements, including the interconnection array structure can be realized by an array of multiple-injection devices.

It is expected that during the life of a patent maturing from this application many relevant FLAME will be developed and the scopes of these and other terms herein are intended to include all such new technologies a priori.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment and the present description is to be construed as if such embodiments are explicitly set forth herein. Conversely, various features of the invention, which are, for brevity, described in the context of a single embodiment, may also be provided separately or in any suitable subcombination or may be suitable as a modification for any other described embodiment of the invention and the present description is to be construed as if such separate embodiments, subcombinations and modified embodiments are explicitly set forth herein. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. An optical response shaper and/or a modulator device with multiple injection, the device comprising:
a resonator having an enclosed geometric structure;
at least two injection optical waveguides between an input port and a second end, the optical waveguides approaching the resonator at respective approach points;
coupling regions between said resonator and said injecting waveguides at said approach points respectively, the coupling regions providing optical coupling between said resonator and said injecting waveguides, the coupling regions being configured to inject at least two light signals to said resonator at said approach points, each light signal having a respective wavelength, said coupling regions being configured to inject said at least two light signals to move in said resonator in a single rotational sense;
an output port at a second end of at least one of said injection optical waveguides; and
at least two actively tunable elements located at preselected locations along said injection optical waveguides, said actively tunable elements being tunable to operate on said input signals in predefined ways, thereby to provide to said output a plurality of shapes of frequency or time responses for each input signal respectively, such that each input is mapped to a distinct output response.

2. The optical response shaper of claim 1, being an optically linear device.

3. The optical response shaper of claim 2, wherein said at least two actively tunable elements, said active tunable elements being configured to control different wavelengths differently.

4. The optical response shaper of claim 3, wherein said actively tunable elements are configured to affect different wavelengths simultaneously and respectively differently.

5. The optical response shaper of claim 4, wherein said active tunable elements comprise couplers and phase shifters at said coupling regions, said couplers and phase shifters being tunable by applied voltages or by temperature or by induced stress or by optical power via a nonlinear effect.

6. The optical response shaper of claim 4, further comprising at least one phase shifting element.

7. The optical response shaper of claim 3, comprising at least one additional active tunable element.

8. The optical response shaper of claim 3, further comprising at least one electrode placed at the vicinity of at least one of said active tunable elements, said additional electrode being for programmably altering a respective coupling coefficient to vary said predetermined frequency response or time response.

9. The optical response shaper of claim 3, further comprising at least one heating element placed at the vicinity of at least one of said active tunable elements, said heating element being for programmably altering a respective coupling coefficient by controllably altering a temperature, thereby to vary resulting frequency responses or time responses.

10. The optical response shaper of claim 3, comprising an electrode over each coupling region respectively, thereby to alter coupling coefficients at each coupling region.

11. The optical response shaper of claim 1, comprising phase shifting elements associated with said waveguides, said phase shifting elements being external to said resonator.

12. The optical response shaper of claim 1, having at least three input ports.

13. The optical response shaper of claim 1, having at least four input ports.

14. The optical response shaper of claim 1, wherein said parameters comprise one member of the group consisting of resonator parameters, tuning electrode parameters, voltages, temperatures, stress, optical power or any known phenomenon that change the phase or amplitude of the light wave.

15. The optical response shaper of claim 5, wherein one member of the group consisting of an applied voltage, a temperature, an induced stress and optical power is provided to at least one of said tunable elements as a control signal.

16. An array of at least two optical response shapers according to claim 1.

17. The array of claim 16, wherein respective active tunable elements on each optical response shaper in said array is set to give an overall array output.

18. The array of claim 16, configured as a permutation matrix for controlled routing.

19. The array of claim 16, configured to provide dynamic switching operations.

20. The array of claim 16, configured to provide a Butler matrix.

21. The array of claim 20, wherein said Butler matrix is an active Butler matrix comprising said tunable elements in said array.

22. The array of claim 16, configured to provide an artificial neural network.

23. The array of claim 16, forming an optical field programmable gate array (OFPGA).

24. The array of claim 23, comprising tuning elements, the tuning elements having inputs, the array configured to allow field programming by changing at least one member of the group of tuning element inputs consisting of control voltages, and temperature.

25. The array of claim 24, wherein said tuning elements comprise one member of the group consisting of couplers, phase-shifters and electrodes.

26. An optical response shaping method comprising:
injecting at least two light signals of respectively different wavelengths to waveguides, the waveguides optically coupled to a resonator having a closed geometric structure, the waveguides leading to at least one output;
coupling the signals to the resonator such that said at least two light signals move in said resonator in a single rotational sense;
actively tuning using at least two elements located at preselected locations along said waveguides, to operate on said input signals in predefined ways, thereby to provide to said output a plurality of shapes of frequency or time responses for each input signal respectively, such that each input is mapped to a distinct output response.
